(19) United States
(12) Patent Application Publication
(10) Pub. No.: US 2022/0256098 A1
(43) Pub. Date: Aug. 11, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TOSHIMITSU UESAKA, TOKYO (JP)

(21) Appl. No.: 17/628,859

(22) PCT Filed: Jun. 26, 2020
(86) PCT No.: PCT/JP2020/025269

§ 371 Date: Jan. 20, 2022

(30) Foreign Application Priority Data
Jul. 30, 2019 (JP) 2019-139785

(51) Int. Cl. H04N 5/262; G06V 10/22; G06T 5/00; H04N 5/232

(52) U.S. Cl. CPC H04N 5/2621; H04N 5/23293; G06T 5/002; G06V 10/22

(57) ABSTRACT

An apparatus and a method are provided to enable performance recording without incurring problems of infringement of portrait rights or privacy. The apparatus includes a data processing section that receives input of a captured image for image processing. The data processing section changes a human image area included in a predetermined partial area within the captured image into an image denying personal identification. For example, a blurring process is carried out. A blurring process target area is determined on the basis of information input from a user terminal via a short-range communication section. After completion of the process of determining the area, a recording process is started in response to a recording start request input from the user terminal via the short-range communication section. Before completion of the area determination process, the recording process is not executed even when the recording start request is input.

### TECHNICAL FIELD

The present disclosure relates to an information processing apparatus, an information processing method, and a program. More particularly, the disclosure relates to an information processing apparatus, an information processing method, and a program for recording performances carried out in public squares such as parks.

### BACKGROUND ART

In recent years, there has been a sudden increase in the number of users making use of video distribution systems over networks. Videos of performances by numerous users are uploaded to servers in a cloud for viewing by large numbers of people.

The users who record videos are called “performers,” for example. The performers do various performances in front of cameras to have their performances recorded.

In order to record videos, it is necessary to provide a suitable recording environment including cameras for recording images and microphones for acquiring sounds, for example.

However, it is a hassle for novice users to configure the recording environment in which the cameras and microphones are to be set up.

To solve such a problem, a video recording square in a public venue, such as a park furnished with the recording environment including the cameras and microphones may conceivably be set up for use by anybody.

However, recording videos in such a public space could inadvertently capture many passersby whose images could be spread over the network. This can lead to problems of the infringement of the passersby's portrait rights and privacy.

PTL 1 (PCT Patent Publication No. WO2015/136796) discloses a configuration for solving the above problem.

What is disclosed in PTL 1 is the configuration by which, if human images are included in an image captured by a surveillance camera, for example, the captured image is subjected to image processing such as filling of the human images with black color, before being transferred to the server. The configuration is designed to deny identification of the captured persons even if their images are spread from the server.

However, the configuration described in PTL 1 also causes the performers to be filled with black color through the image processing and is thus unfit for recording performance videos.

### CITATION LIST

### Patent Literature

[PTL 1]

PCT Patent Publication No. WO2015/136796

### SUMMARY

### Technical Problem

The present disclosure has been made in view of the above circumstances and aims to provide an information processing apparatus, an information processing method, and a program for enabling the recording of performances by performers in a public venue without infringing the privacy of many passersby.

### Solution to Problem

According to a first aspect of the present disclosure, there is provided an information processing apparatus including a data processing section configured to receive input of a captured image for image processing,

in which the data processing section performs the image processing of changing a predetermined partial area within the captured image into an unidentifiable image.

According to a second aspect of the present disclosure, there is further provided an information processing system including

a user terminal, and

a recording system,

in which the recording system includes
a data processing section configured to receive input of a captured image for image processing, and
a short-range communication section configured to have a limited communicable area, and

the data processing section
receives input of image processing area designation information from the user terminal via the short-range communication section, and
on the basis of the input information, performs the image processing of changing, into an unidentifiable image, a partial area selected from the captured image in accordance with the image processing area designation information.

According to a third aspect of the present disclosure, there is further provided an information processing method to be executed by an information processing apparatus,

in which the information processing apparatus includes a data processing section configured to receive input of a captured image for image processing, and

the data processing section performs the image processing of changing a predetermined partial area within the captured image into an unidentifiable image.

According to a fourth aspect of the present disclosure, there is further provided an information processing method to be executed by an information processing system having a user terminal and a recording system,

in which the recording system includes
a data processing section configured to receive input of a captured image for image processing, and
a short-range communication section configured to have a limited communicable area, and

the data processing section
receives input of image processing area designation information from the user terminal via the short-range communication section, and
on the basis of the input information, performs the image processing of changing, into an unidentifiable image, a partial area selected from the captured image in accordance with the image processing area designation information.

According to a fifth aspect of the present disclosure, there is further provided a program for causing an information processing apparatus to perform information processing,

in which the information processing apparatus includes a data processing section configured to receive input of a captured image for image processing, and

the program causes the data processing section to perform the image processing of changing a predetermined partial area within the captured image into an unidentifiable image.

Incidentally, the program of the present disclosure may be offered via a storage medium or a communication medium in a computer-readable format to an information processing apparatus or a computer system capable of executing diverse program codes. When supplied with such a program in a computer-readable manner, the information processing apparatus or the computer system performs the processes defined by the program.

Other objects, features, and advantages of the present disclosure will become apparent upon a reading of the ensuing more detailed description of an embodiment of the present disclosure with reference to the appended drawings. In this description, the term “system” refers to a logical aggregate configuration of a plurality of apparatuses. The apparatuses in such a configuration may or may not be housed in a single enclosure.

According to the configuration of one embodiment of the present disclosure, an apparatus and a method that enable to record performances without incurring problems of infringement of portrait rights or privacy are achieved.

Specifically, the apparatus includes a data processing section configured to receive input of a camera-captured image for image processing. The data processing section changes a human image area included in a predetermined partial area within the captured image into an image denying personal identification. For example, a blurring process is carried out. A blurring process target area is determined on the basis of information input from a user terminal via a short-range communication section. After completion of the process of determining the area, a recording process is started in response to a recording start request input from the user terminal via the short-range communication section. Before completion of the area determination process, the recording process is not executed even in response to the input recording start request.

This configuration thus provides an apparatus and a method for recording performances without incurring problems of infringement of portrait rights or privacy.

The advantageous effects stated in this description are only examples and not limitative of the present disclosure that may provide other advantages as well.

### BRIEF DESCRIPTION OF DRAWINGS

FIG. 1 is a diagram explaining an overview of processing performed by the present disclosure.

FIG. 2 is a diagram explaining an example of a short-range communication enabled area of a recording system.

FIG. 3 is a diagram explaining a configuration example of apparatuses according to the present disclosure.

FIG. 4 is a diagram explaining databases held in a data processing server.

FIG. 5 is a diagram explaining examples of stored data in one database held in the data processing server.

FIG. 6 is a diagram explaining examples of stored data in other databases held in the data processing server.

FIG. 7 is a diagram explaining examples of display data displayed on a user terminal.

FIG. 8 is a diagram explaining another example of display data displayed on the user terminal.

FIG. 9 is a diagram explaining another example of display data displayed on the user terminal.

FIG. 10 is a diagram explaining another example of display data displayed on the user terminal.

FIG. 11 is a diagram explaining another example of display data displayed on the user terminal.

FIG. 12 is a diagram explaining another example of display data displayed on the user terminal.

FIG. 13 is a diagram explaining another example of display data displayed on the user terminal.

FIG. 14 is a sequence diagram explaining a processing sequence performed by an information processing system according to the present disclosure.

FIG. 15 is another sequence diagram explaining the processing sequence performed by the information processing system according to the present disclosure.

FIG. 16 is another sequence diagram explaining the processing sequence performed by the information processing system according to the present disclosure.

FIG. 17 is a diagram explaining a hardware configuration example of the information processing system according to the present disclosure.

### DESCRIPTION OF EMBODIMENT

An information processing apparatus, an information processing method, and a program according to the present disclosure are described below in detail with reference to the accompanying drawings. The description is made under the following headings:

1. Overview of the processing according to the present disclosure

2. Details of the constituent elements of the information processing system

3. Specific examples of the processing using the user terminal

4. Processing sequence of the information processing system according to the present disclosure

5. Hardware configuration example of the apparatuses

6. Summary of the configuration according to the present disclosure

### [1. Overview of the Processing According to the Present Disclosure]

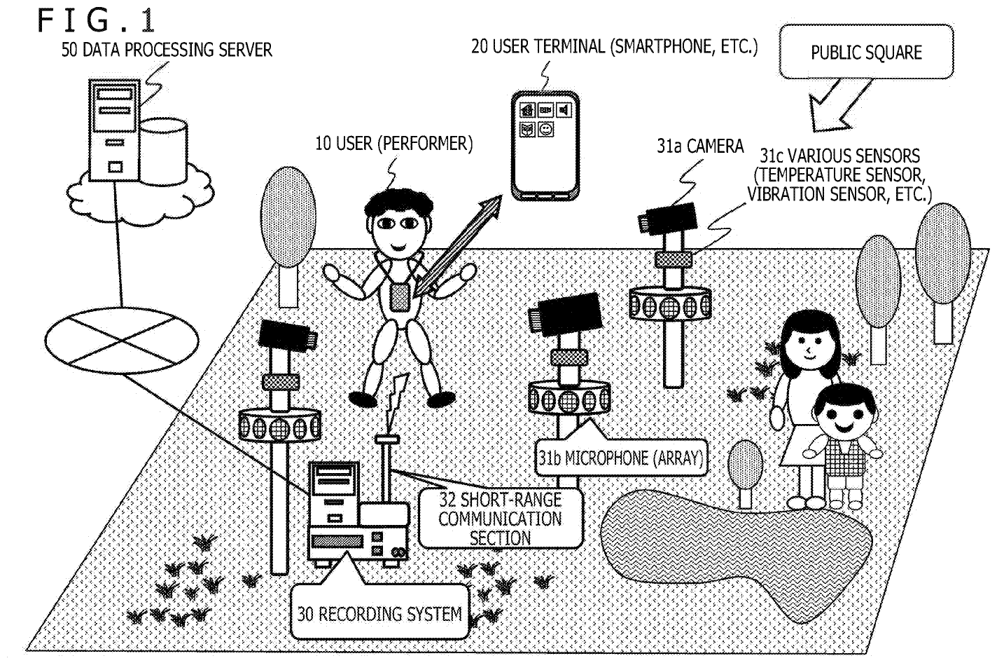

An overview of the processing according to the present disclosure is described below with reference to FIG. 1 and subsequent drawings.

FIG. 1 depicts a public square such as a park for use by a large indefinite number of people.

In the public square, there is a user (performer) 10 who carries out diverse performances.

The user 10 can have his or her performances recorded using a recording system 30 set up in the public square.

The recording system 30 includes a camera 31a, a microphone (array) 31b, and other various sensors (temperature sensor, vibration sensor, etc.) 31c. The information acquired from these sensors (including the camera and microphone) is recorded.

The recorded data includes not only the images and sounds of the performer but also the information acquired from the temperature sensor and vibration sensor.

In this description, the term “image” is meant to signify both still and moving images.

The user 10 holds a user terminal 20 such as a smartphone. The user terminal 20 may be used to conduct short-range communication with the recording system 30. This allows the user 10 to control operations of the recording system 30 such as issue of requests to start and end recording as well as setting and adjustment of the camera and microphone.

In a case where the user 10 starts recording by use of the recording system 30, the user 10 transmits a recording start request from the user terminal 20 to the recording system 30.

Upon receipt of the recording start request from the user terminal 20, the recording system 30 inquires a data processing server 50 to check whether or not the user 10 has the right to use the recording system.

Upon receipt of the inquiry from the recording system 30, the data processing server 50 verifies whether or not the user 10 is registered in a user information database held therein.

Only in the case where the user 10 is verified to be registered in the user information database held in the data processing server 50, the user 10 can proceed with a recording process using the recording system 30.

In a case of ending the recording process, the user 10 transmits a recording end process request from the user terminal 20 to the recording system 30.

Upon receipt of the recording end request from the user terminal 20, the recording system 30 transmits, to the data processing server 50, the recorded data held in a storage section of the recording system 30.

Upon completion of transmission of the recorded data to the data processing server 50, the recording system 30 deletes the recorded data from the storage section thereof.

The data processing server 50 stores the recorded data into a recorded information database held therein.

At a later date, the user 10 can access the recorded information database in the data processing server 50 so as to view or download the recorded data.

A specific sequence of these processes will be described later.

As described above, the user 10 holds the user terminal 20 such as a smartphone. By making use of the user terminal 20, the user 10 can execute short-range communication with the recording system 30 so as to control the operations of the recording system 30 such as the issue of requests to start and end recording as well as the adjustment of setting the camera and microphone.

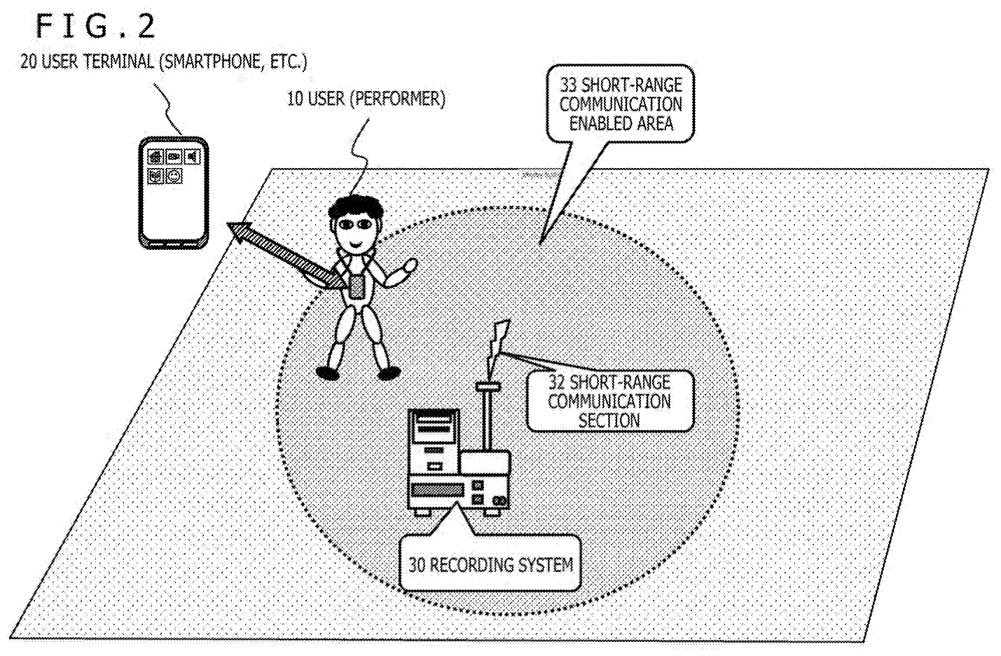

FIG. 2 depicts an example of a short-range communication enabled area 33, i.e., an area where short-range communication between the user terminal 20 and the recording system 30 is enabled.

The communication between the user terminal 20 and the recording system 30 is carried out as short-range communication via a short-range communication section 32 of the recording system 30. For example, communication processing is performed using wireless LAN (WLAN) such as Wi-Fi communication, or Bluetooth (BT; registered trademark) communication.

As depicted in FIG. 2, the short-range communication enabled area 33 is a limited area that includes a performance recording enabled area in the public square, for example.

That is, at locations away from the public square, communication with the recording system 30 is not available, and processes such as the recording start request cannot be executed.

Only in a case where the user 10 is inside the performance recording enabled area in the public square, can the user 10 communicate with the recording system 30 using the user terminal 20 to start recording, set up the camera and microphone, etc.

### [2. Details of the Constituent Elements of the Information Processing System]

Described below are the details of each of the constituent elements of an information processing system according to the present disclosure.

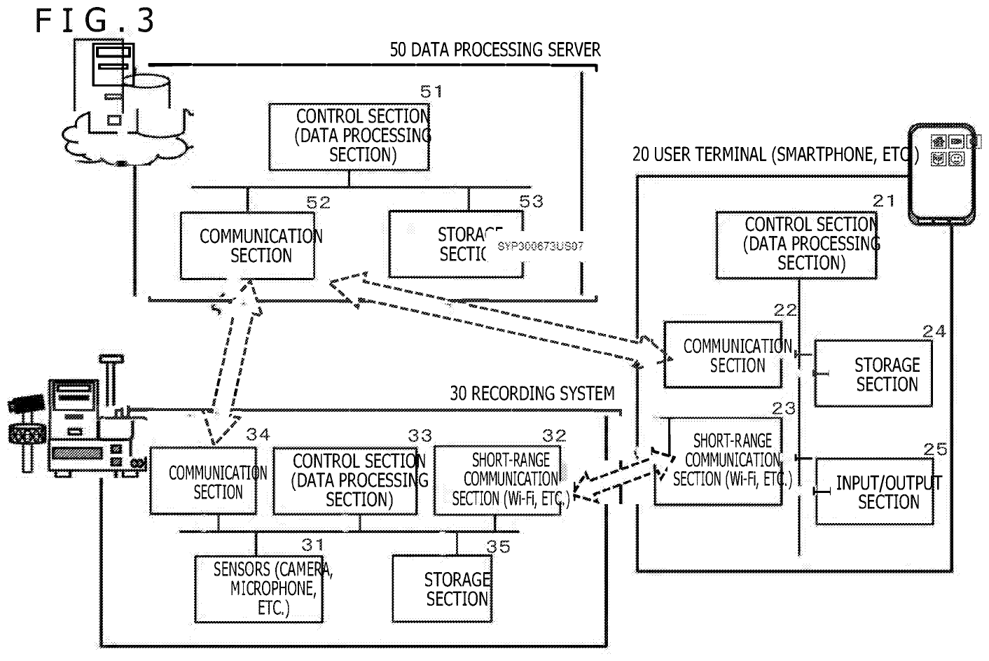

FIG. 3 is a diagram explaining a configuration example of the constituent elements of the information processing system of the present disclosure, i.e., the user terminal 20 such as a smartphone, the recording system 30 set up in the public square, and the data processing server 50 configured as a cloud system, for example.

How the recording system 30 is configured is explained first.

The recording system 30 includes sensors (camera, microphone, etc.) 31, a short-range communication section 32, a control section (data processing section) 33, a communication section 34, and a storage section 35 as illustrated.

The sensors (camera, microphone, etc.) 31 include diverse sensors such as a camera, a microphone, a temperature sensor, and a vibration sensor set up in the public square.

The microphone has a configuration capable of acquiring sound selectively only from a specific direction through beam forming processing, for example. The microphone is further configured to have a microphone arrangement (microphone array structure) capable of detecting the sound individually from different directions.

The sensors 31 may include not only the sensors for sensing physical information but also a receiver capable of being accessed by people who happen to be within a space of the public square (onlookers), the receiver enabling the onlookers to transmit evaluation information regarding the performance, for example.

That is, the receiver is a sensor that receives the evaluation information transmitted from terminals of the onlookers, such as their smartphones, to evaluate the performer.

Specifically, for example, the onlookers start a particular application (e.g., a recording system use application) on their smartphones to input and transmit the evaluation information. The transmitted data is received by the receiver (sensor).

The short-range communication section 32 performs short-range communication with the user terminal 20 for communication therewith. For example, communication processing is performed using wireless LAN (WLAN) such as Wi-Fi communication, or Bluetooth (BT; registered trademark) communication.

As described above with reference to FIG. 2, the communication is available solely inside the specific area in the public square where the recording of performances is enabled, for example.

The control section (data processing section) 33 is a data processing section that carries out various processes of the recording system 30. The control section 33 controls communication with the user terminal 20 and the data processing server 50, and executes a recording process, adjustment of diverse sensors (camera, microphone, etc.), a control process, etc., for example.

It is noted that these processes are carried out by programs stored in the storage section 35, for example. The control section (data processing section) 33 includes a processor, such as a CPU, having a program execution function.

The communication section 34 is used for communication with the data processing server 50 over the Internet, for example.

The storage section 35 is used as an area for storing the recorded data. The storage section 35 is also used as an area for storing sensor setting data and parameters. The storage section 35 is further used as an area for storing various processing programs to be executed by the control section (data processing section) 33 and as a work area for use during execution of diverse processes.

Explained next is how the user terminal 20 such as a smartphone owned by users such as performers is configured.

As depicted in FIG. 3, the user terminal 20 includes a control section (data processing section) 21, a communication section 22, a short-range communication section 23, a storage section 24, and an input/output section 25.

The control section (data processing section) 21 is a data processing section that carries out various processes of the user terminal 20. The control section 21 controls communication with the recording system 30 and with the data processing server 50, performs UI display processing for setting and adjusting the camera and microphone upon execution of the recording process, and carries out processing control such as processing for transmitting user setting information to the recording system 30.

These processes are carried out by programs stored in the storage section 24, for example. The control section (data processing section) 21 includes a processor, such as a CPU, having the program execution function.

The communication section 22 is used for communication with the data processing server 50 over the Internet or telephone network, for example.

The short-range communication section 23 performs short-range communication for use in communicating with the recording system 30. For example, communication processing is performed using wireless LAN (WLAN) such as Wi-Fi communication, or Bluetooth (BT; registered trademark) communication.

As described above with reference to FIG. 2, the communication is available solely inside the specific area in the public square where the recording of performances is enabled, for example.

The storage section 24 is used as an area for storing various processing programs to be executed by the control section (data processing section) 21 and as a work area during execution of diverse processes. The storage section 24 is further used as an area for storing various parameters including user ID information and user terminal ID information.

The input/output section 25 includes a display section, a sound output section, and an input section. For example, the input/output section 25 includes a liquid crystal display, a speaker, a microphone, various operation switches, a touch panel, and the like.

How the data processing server 50 is configured is explained next.

As depicted in FIG. 3, the data processing server 50 includes a control section (data processing section) 51, a communication section 52, and a storage section 53.

The control section (data processing section) 51 is a data processing section that carries out diverse processes of the data processing server 50. The control section 51 controls communication with the recording system 30 and with the data processing server 50, verification of user registration information upon execution of the recording process, processes of storing the recorded data, processes responding to requests from the user terminal 20 to download the recorded data, and the like.

These processes are carried out in accordance with programs stored in the storage section 53, for example. The control section (data processing section) 51 includes a processor, such as a CPU, having the program execution function.

The communication section 22 is used for communication with the recording system 30 and with the user terminal 20 over the Internet or telephone network, for example.

The storage section 23 is used as an area for storing the recorded data and as an area for storing user information. The storage section 23 is further used as an area for storing diverse processing programs to be executed by the control section (data processing section) 21 and as a work area during execution of various processes.

The storage section 53 in the data processing server 50 stores a plurality of databases.

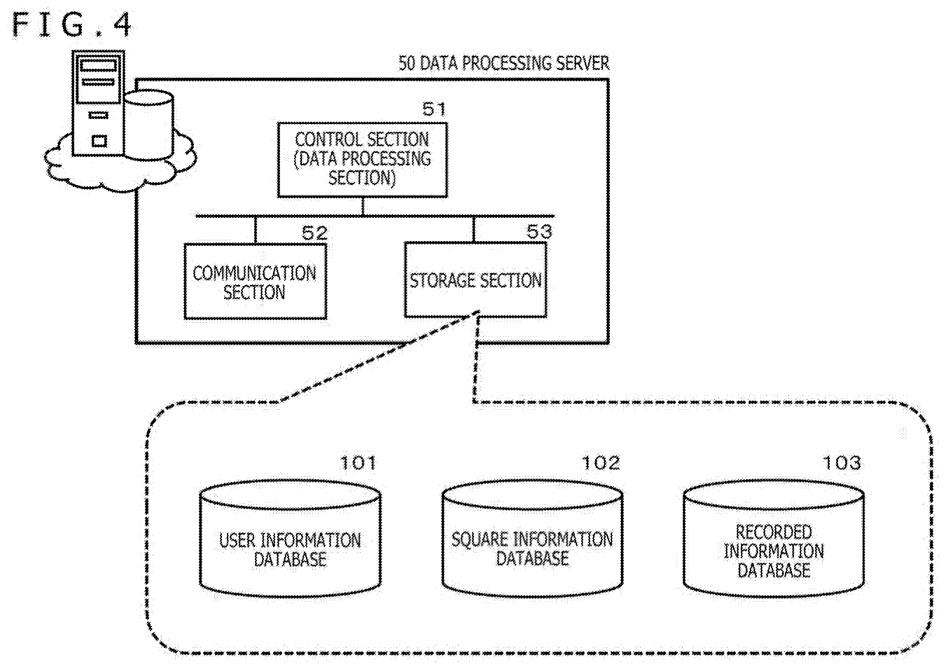

Explained below with reference to FIG. 4 and subsequent drawings are the databases stored in the storage section 53 of the data processing server 50.

As depicted in FIG. 4, the storage section 53 in the data processing server 50 stores the following databases.
(1) User information database 101
(2) Square information database 102
(3) Recorded information database 103

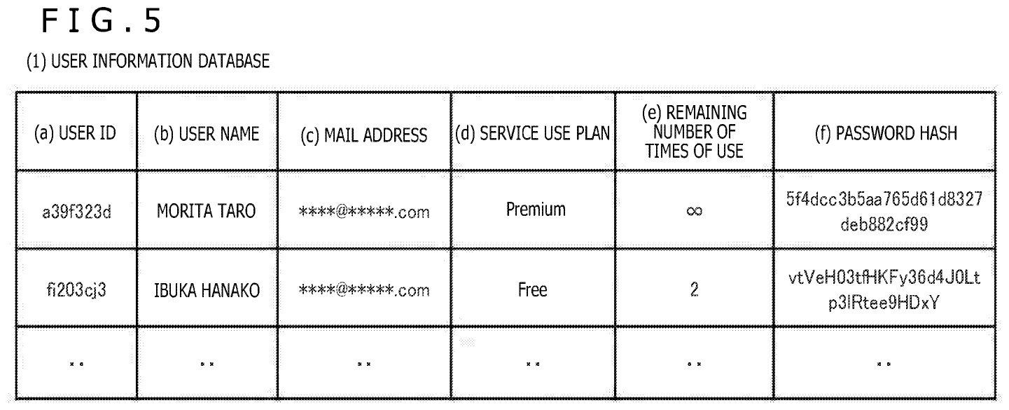

The data stored in each of these databases is explained below with reference to FIG. 5 and subsequent drawings.

The user information database 101 is a database that records the registration information regarding the user desirous of making the recording by use of the recording system 30. Before making the recording using the recording system 30, the user accesses the data processing server 50 through the user terminal 20 to transmit the user information to the data processing server 50 in advance. The data processing server 50 registers the data received from the user terminal 20 to the user information database 101.

The square information database 102 is a database that registers information regarding the squares where the recording process by use of the recording system 30 is enabled. For example, information regarding the equipment of each square is registered in the database.

A user desirous of making the recording using the recording system 30 accesses the data processing server 50 by use of the user terminal 20. This allows the user to view the information registered in the square information database 102.

The recorded information database 103 is a database that registers locations and dates at which the recording process is performed by use of the recording system 30, access information for acquiring the recorded data, etc.

The user who has made the recording by use of the recording system 30 accesses the data processing server 50 using the user terminal 20. This allows the user to view the recorded data by making use of the access information stored in the recorded information database 103 and also to download the recorded data to the user terminal 20.

Examples of these databases are explained below with reference to FIG. 5 and subsequent drawings.

Explained first with reference to FIG. 5 are examples of data stored in the user information database 101.

FIG. 5 is a diagram explaining examples of the stored data in the user information database 101 stored in the storage section 53 of the data processing server 50.

As depicted in FIG. 5, the following items of data are stored in association with each of the data entries in the user information database 101.
(a) User ID
(b) User name
(c) Mail address
(d) Service use plan
(e) Remaining number of times of use
(f) Password hash

(a) User ID is a unique ID assigned to the user.

(b) User name is the name entered by the user upon registration of service use.

(c) Mail address is the contact mail address entered by the user upon registration of service use.

(d) Service use plan indicates the type of service to which the user subscribes. For example, the “Free” plan is a plan that can be used for free. This is a use plan that limits the number of times the recording system 30 can be used per month.

The “Premium” plan is a paid plan permitting unlimited use of the recording system 30 per month.

(e) Remaining number of times of use is the remaining number of times the user can use the recording system 30.

(f) Password hash is the data obtained by encrypting a password entered by the user upon registration.

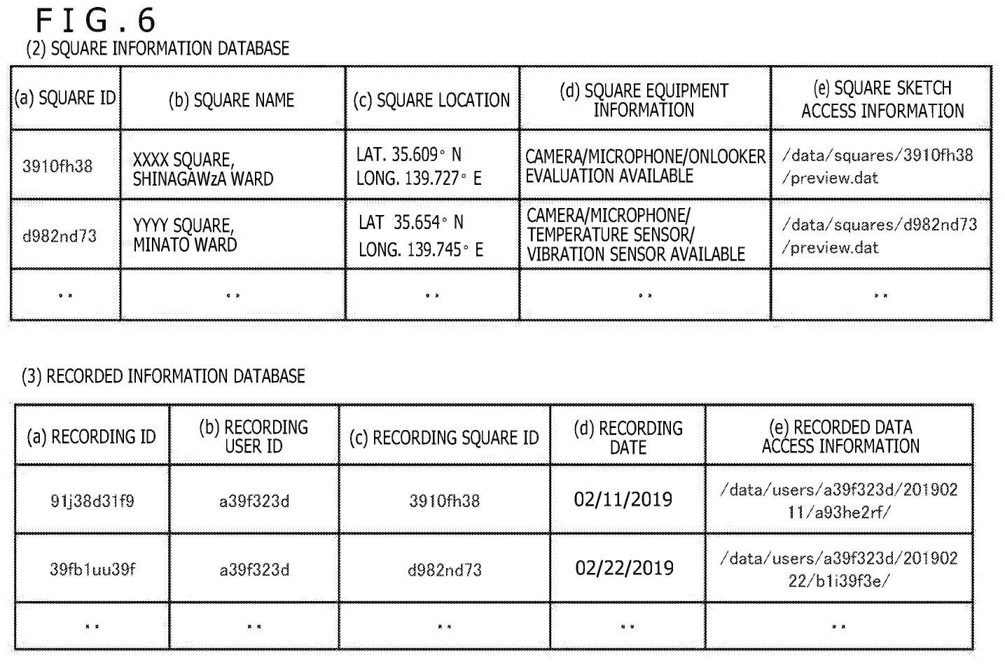

Explained next with reference to FIG. 6 are examples of data stored in the square information database 102.

As depicted in FIG. 6, the following items of data are stored in association with each of the data entries in the square information database 102.
(a) Square ID
(b) Square name
(c) Square location
(d) Square equipment information
(e) Square sketch access information

(a) Square ID is a unique ID assigned to the square where the recording system 30 is set up.

(b) Square name is a name of the square where the recording system 30 is set up.

(c) Square location is a location (longitude and latitude information) of the square where the recording system 30 is set up.

(d) Square equipment information is information regarding the recording system equipment of the square where the recording system 30 is set up.

(e) Square sketch access information is access information for viewing guide information and a sketch regarding the square where the recording system 30 is set up.

Explained next with reference to FIG. 6 is a data configuration example of the recorded information database 103.

As depicted in FIG. 6, the following items of data are stored in association with each of the data entries in the recorded information database 103.
(a) Recording ID
(b) Recording user name
(c) Recording square ID
(d) Recording date
(e) Recorded data access information

(a) Recording ID is a unique ID assigned to each recording process conducted by the user with the recording system 30.

(b) Recording user name is a unique ID of the user who has made the recording. This is the same in terms of value as the “User ID” in a user registration information table.

(c) Recording square ID is a unique ID of the square where the recording is made.

(d) Recording date is a date at which the recording process is carried out.

(e) Recorded data access information is information for access to the recorded data including actually recorded sound data and moving image data.

It is noted that the recorded data may also include sensing data such as information regarding evaluation by onlookers and degrees of excitement of the onlookers.
[3. Specific Examples of the Processing Using the User Terminal]

Specific examples of the processing that uses the user terminal 20 are explained next.

A user desirous of making the recording by use of the recording system 30 in the public square first accesses the data processing server 50 to make user registration. After the registration, the user searches for a square in which to make the recording, i.e., a square where the recording system 30 is set up, and determines a location in which the recording is to be made.

Thereafter, the user causes the user terminal 20 to conduct short-range communication with the square system 30 to set the sensors such as the camera and microphone, before executing the recording.

After the recording, the data transmitted (uploaded) from the recording system 30 to the data processing server 50 can be viewed on, or downloaded to, the user terminal 20.

As described above, there are diverse processes to be carried out by use of the user terminal 20.

These processes can be executed, for example, by the user terminal 20 activating a specific application (recording system use application).

A user desirous of making the recording using the recording system 30 in the public square first accesses the data processing server 50 to make user registration. This process is carried out by inputting, to the user terminal 20, the information to be registered to the user information database described above with reference to FIG. 5, and by having the input information transmitted from the user terminal 20 to the data processing server 50.

Next, the user searches for a square in which to make the recording, i.e., a square where the recording system 30 is set up, and determines a location in which to make the recording.

For example, the user uses the user terminal 20 to view the information registered in the square information database in the data processing server 50. Then, the user acquires the right of use by making use of the viewed data.

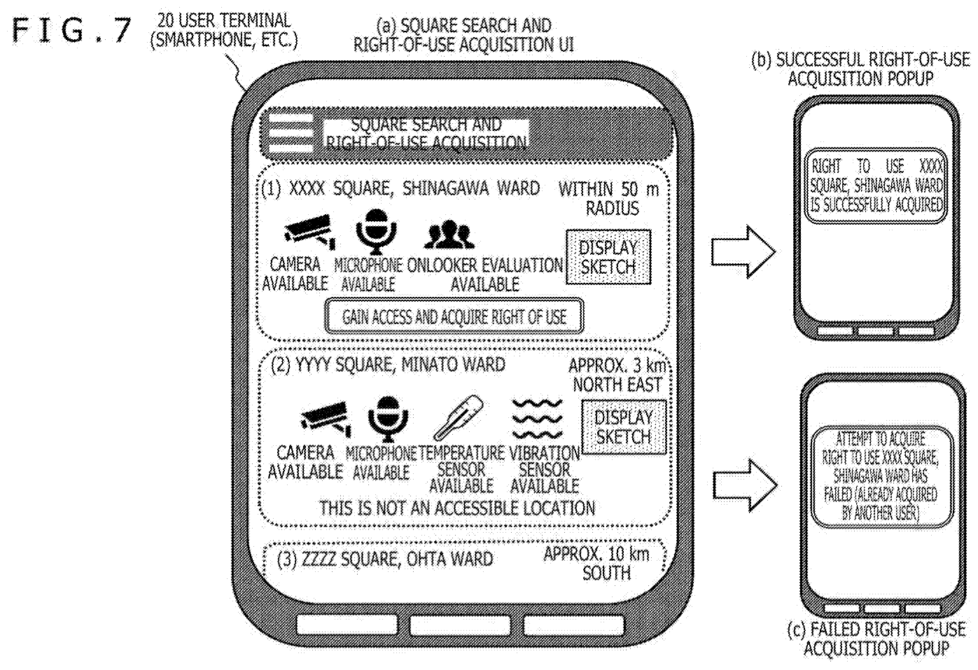

FIG. 7 depicts an example of a UI (user interface) displayed on the user terminal upon search for a square and upon execution of the process of acquiring the right to use the square.

(a) Square Search and Right-of-use Acquisition UI illustrated in FIG. 7 is a UI displayed upon access from the user terminal 20 to the square information database in the data processing server 50. The user terminal 20 displays the information registered in the square information database.

In the illustrated example,

as information regarding (1) . . . Square, Shinagawa Ward,

the recording system equipment information is displayed. Also displayed are information regarding a distance from the current location (50 m), an icon (button) for requesting sketch display, and a “Gain Access and Acquire Right of Use” operation icon.

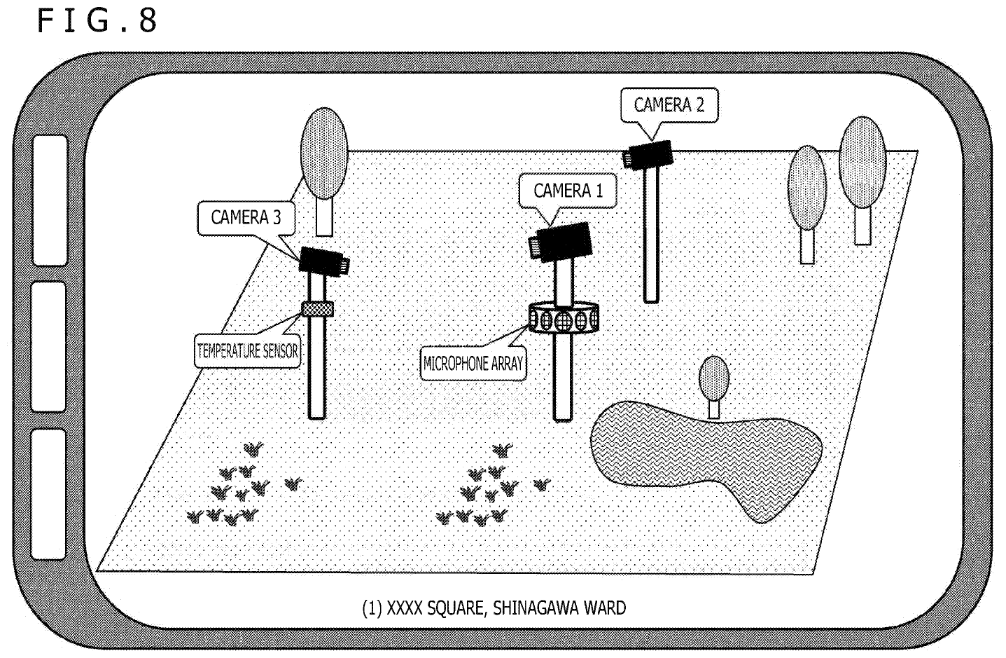

When the user operates (i.e., touches) the icon (button) for requesting sketch display, data such as that illustrated in FIG. 8 is displayed, for example.

This sketch is derived from the data accessed in accordance with “Square Sketch Access Information” recorded earlier in (2) Square information database in FIG. 6.

By referencing the sketch, the user is able to know detailed information regarding the camera and microphone arrangements and the like.

In order to use this square, the user needs to perform a process of acquiring the right to use the square. The process of acquiring the right of use is executed by the user terminal 20 accessing the recording system 30 of the square.

This process can be started by touching the “Gain Access and Acquire Right of Use” operation icon in the UI depicted in FIG. 7.

When the user touches the “Gain Access and Acquire Right of Use” operation icon, the user terminal 20 starts short-range communication with the recording system 30 in the public square.

It is to be noted, as described above with reference to FIG. 2, that the available range of short-range communication between the user terminal 20 and the recording system 30 is limited. In a case where the user terminal 20 is not within the communication enabled range, the communication is not available, and the right to use the square cannot be acquired.

In a case where successfully established short-range communication between the user terminal 20 and the recording system 30 enables the user to acquire the right to use the square, a popup indicator such as (b) Successful right-of-use acquisition popup in FIG. 7 is displayed.

On the other hand, in a case where the short-range communication between the user terminal 20 and the recording system 30 has failed, where the right to use the square has already been acquired by another user, or where the user has otherwise failed to acquire the right to use the squire, a popup indicator such as (c) Failed right-of-use acquisition popup in FIG. 7 is displayed.

When the user terminal 20 displays the popup indicator such as (b) Successful right-of-use acquisition popup in FIG. 7 indicating that the user has acquired the right to use the square, the user performs short-range communication between the user terminal 20 and the recording system 30 to make various settings for executing the recording process.

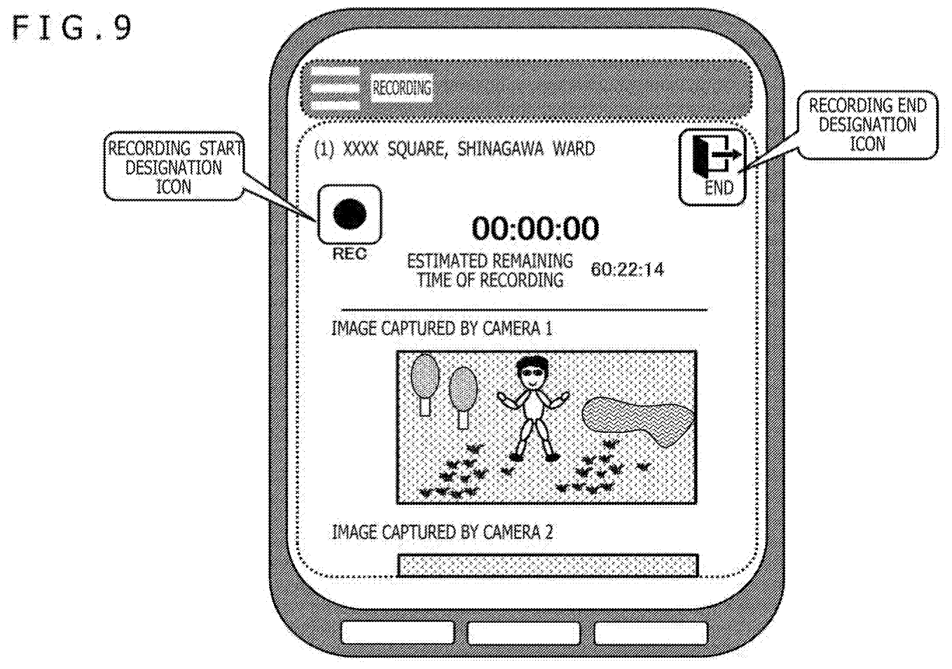

Described below with reference to FIG. 9 are examples of data displayed on the user terminal 20 upon execution of this process.

FIG. 9 depicts an example screen displayed in a case where the process of starting or ending the recording process is carried out. In a case of performing the process of starting the recording process, a recording start designation icon is operated (touched), and in a case of ending the recording process, a recording end designation icon is operated (touched).

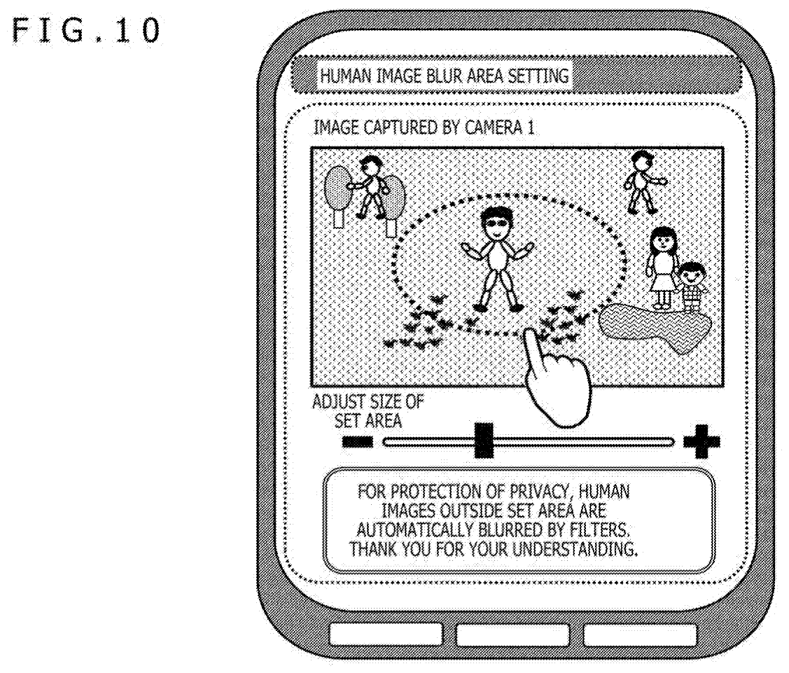

In the case of performing the process of starting the recording process, however, a process of setting a blur filter applied/non-applied area and a process of setting a sound acquisition area need to be carried out with respect to human images included in the captured images, as will be explained below with reference to FIG. 10 and subsequent drawings.

In a case where these processes have yet to be performed, the recording will not be started even when the recording start designation icon is operated (touched).

First, the user performs the process of adjusting the camera by use of the screen depicted in FIG. 9.

In a case where the recording system 30 has a plurality of cameras, images captured by each of the cameras are displayed.

By viewing the images captured by the cameras, the user is able to adjust the camera directions, the zoom settings, etc.

Moreover, FIG. 10 depicts a screen for making the settings to blur images of people around the user 10 acting as a performer.

If the images of the people around the user 10 acting as the performer are recorded as part of the captured images and if the recorded data stored in the data processing server 50 is leaked, there is a possibility that the portrait rights and privacy of the nearby people may be infringed on.

To prevent such problems, the recording system 30 proceeds with the process of recording captured images by carrying out a filtering process to blur the images of nearby people.

FIG. 10 depicts a UI for determining the area where the process of blurring with filters is not performed.

In FIG. 10, the area circumscribed by a dotted line is an area where the process of blurring with filters is not carried out. The area outside of the dotted line area is set to be the area where the process of blurring with filters is performed.

The images subject to the blurring process are basically areas around the people only.

The user (performer) 10 can change the size and shape of the dotted line area in FIG. 10 to adjust the blur filter applied/non-applied area as desired.

It is noted that, in a case where the recording system 30 is equipped with a plurality of cameras, the blur filter applied and non-applied areas are adjusted for each of the cameras.

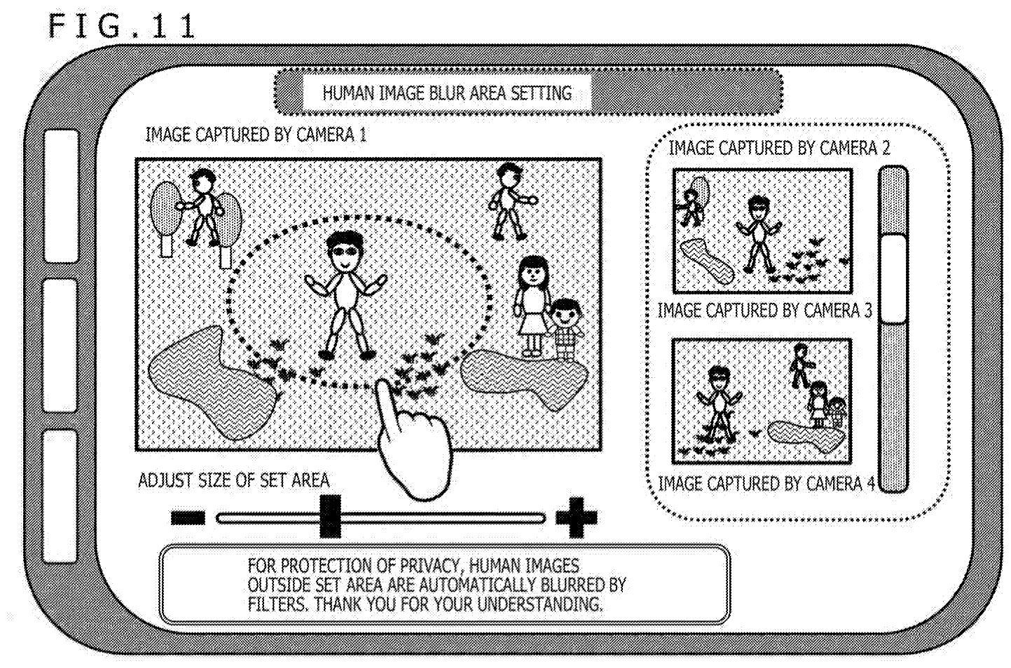

As depicted in FIG. 11, the image captured by each camera is displayed in small size on the right side of a display area. The user selects one of these camera-captured images for display on a main screen display area to the left. The user then changes and sets the size and shape of the dotted line area in terms of blur filter setting area demarcation.

The user determines the blur filter applied and non-applied areas for the images to be captured by all cameras. Unless this process is complete, the user cannot transition to the recording process.

When the user has determined the blur filter applied and non-applied areas for the images to be captured by all cameras, the determination-related information is recorded to the storage section 35 of the recording system 30.

The control section (data processing section) 33 of the recording system 30 performs the process of detecting human images from the blur filter applied area in each of the images captured by the cameras and the process of applying blur filters to the detected human images to such an extent that the imaged people cannot be identified, before recording the captured images.

Detection of human-occupied areas is executed, for example, by performing a process of checking against pattern images, or a process of detecting humans using learning data by application of semantic segmentation, for example.

Semantic segmentation is a technology that identifies to which object category each of the picture elements (pixels) constituting an image belongs on the basis of the degree of coincidence between dictionary data for object identification (learned data) on one hand and objects within a camera-captured image on the other hand, the dictionary data being constituted by registered information regarding the shapes of diverse objects and other features.

The semantic segmentation permits identification of the types of various objects included in the camera-captured images, such as humans, cars, buildings, and roads.

It is noted that the target of the blurring process is not limited to the human-occupied areas but the blurring process may alternatively be targeted for the entire blur filter applied area. As another alternative, object areas that could lead to problems of privacy or copyrights, such as the human-occupied areas, character areas, and signboards, may be set to be the blur filter applied area.

As a further alternative, the blurring process may be replaced with image processing that changes real objects into unidentifiable forms upon display through filling with color or superposition of pattern images, for example.

After completing the setting of the blur filter applied and non-applied areas for each camera-captured image, the user then sets a sound acquisition area with microphones of the recording system 30.

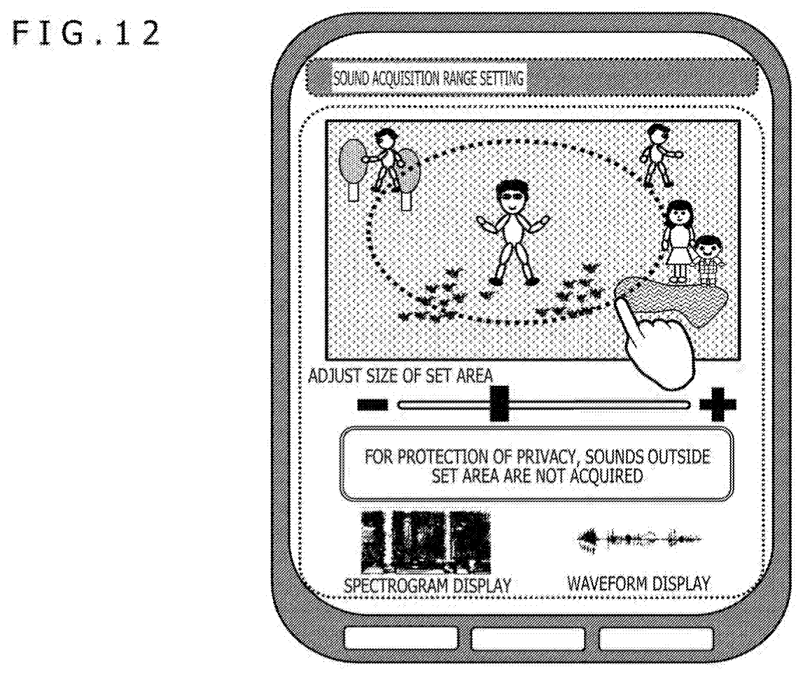

The display data depicted in FIG. 12 constitutes a screen for setting the sound acquisition area with the microphones of the recording system 30.

The microphones of the recording system 30 are configured to selectively acquire the sound from a specific direction through beam forming processing, for example.

Sounds other than those in the selected direction are seldom acquired and recorded. This process is also intended not to record the voices of passersby and the like other than those of the performer. That is, the process is designed to prevent infringement of privacy, etc.

However, in a case where the voices of onlookers watching the performance of the user (performer) are to be acquired, the area where the onlookers are gathered is set as a sound acquisition area.

The user can set or change the sound acquisition area as desired by use of the display screen depicted in FIG. 12.

In FIG. 12, the area circumscribed by a dotted line in the display screen is the sound acquisition area. Being outside of the dotted line area means being outside of the sound acquisition area. Sounds from outside of the dotted line area are seldom recorded.

By use of the display screen depicted in FIG. 12, the user can change the size and shape of the dotted line area to set or change the sound acquisition area as desired.

When the user determines the sound acquisition area, the determination-related information is recorded to the storage section 35 of the recording system 30.

In accordance with the setting information recorded in the storage section 35, the control section (data processing section) 33 of the recording system 30 adjusts the microphones in such a manner as to acquire solely the sound from the sound acquisition area set by the user through beam forming processing, etc.

After setting the distinction between the blur filter applied area and the blur filter non-applied area for the captured images described above with reference to FIGS. 10 and 11, and after setting the sound acquisition area described above with reference to FIG. 12, the user can start the recording.

The recording is started by operating (touching) the recording start designation icon (REC button) on the screen explained above with reference to FIG. 9.

When the user operates (touches) the recording start designation icon (REC button) displayed on the user terminal 20, the operation-related information is transmitted to the recording system 30 through short-range communication.

Upon receipt of the information regarding the operation (touch) of the recording start designation icon (REC button), the control section 33 of the recording system 30 starts the recording process to record the recorded data to the storage section 35.

Thereafter, when the user operates (touches) the recording end designation icon displayed on the user terminal 20, the operation-related information is transmitted to the recording system 30 through short-range communication.

Upon receipt of the information regarding the operation (touch) of the recording end designation icon by the recording system 30, the control section 33 of the recording system 30 terminates the recording process.

Further, the control section 33 of the recording system 30 transmits (uploads), to the data processing server 50, the recorded data stored in the storage section 35.

When the control section 33 of the recording system 30 has transmitted (uploaded) all recorded data in the storage section 35 to the data processing server 50, the control section 33 deletes the data from the storage section 35.

The images in the recorded data transmitted (uploaded) to the data processing server 50 are those that have undergone the application of blur filters to the human images in the blur filter applied area. That is, all human images in the blur filter applied area are blurred to such an extent that all people are unidentifiable.

Furthermore, the sound in the recorded data transmitted (uploaded) to the data processing server 50 constitutes sound data including little sound from outside of the sound acquisition area.

As described above, the recording system 30 of the present disclosure is configured to require that the blur filter applied/non-applied area be set for images and that the sound acquisition area be set before start of the recording. Only after these settings are completed, the recording system 30 permits start of the recording.

This configuration turns the images and sounds other than those of the performer into unidentifiable forms out of the recorded data. Even if, by any chance, the recorded data is leaked and spread, the problems of infringement of portrait rights or privacy of people, etc. will not occur.

Upon completion of the recording by the user, with the recorded data transmitted (uploaded) from the recording system 30 to the data processing server 50, the data processing server 50 stores the recorded data into the storage section 53 thereof and further registers the recorded data to the recorded information database explained above with reference to FIG. 6.

Thereafter, the user 10 can use the user terminal 20 to access the recorded information database in the data processing server 50 to view or download the recorded data.

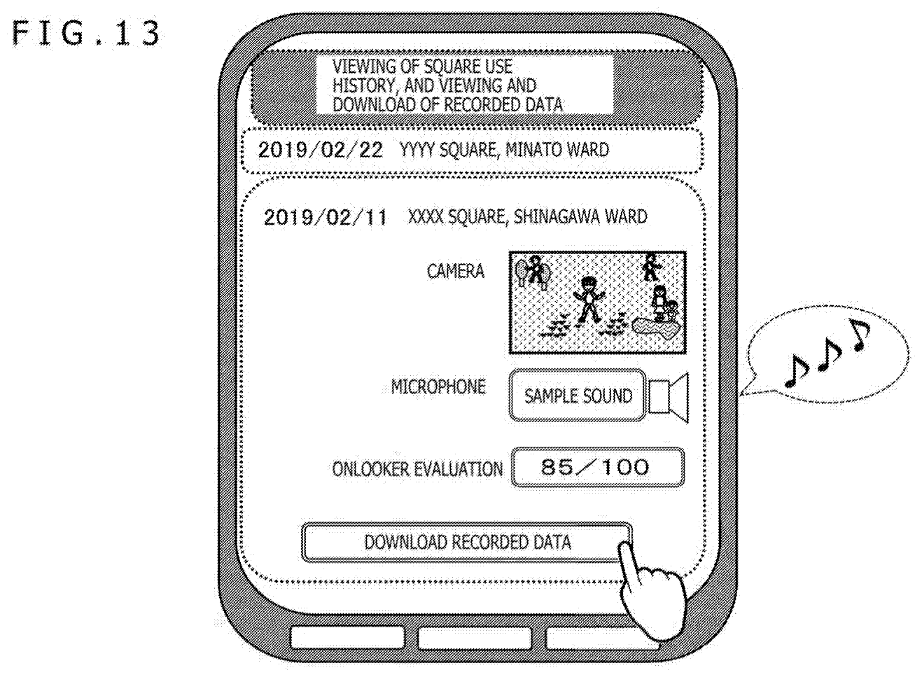

FIG. 13 depicts an example of the display data appearing on the user terminal 20 when the process of viewing or downloading the recorded data is carried out.

As depicted in FIG. 13, the display section of the user terminal 20 is configured to display a thumbnail representing the camera-captured image in accordance with the recording date and recording location serving as information regarding the recorded data. The user terminal 20 is further configured to be able to output a sample of the recorded sound as well.

In a case where the data of evaluation by onlookers has been acquired during the recording, the evaluation data is also displayed.

Further, operating (touching) a “Download Recorded Data” icon permits download of the recorded data from the storage section 53 of the data processing server 50 to the user terminal 20.
[4. Processing Sequence of the Information Processing System According to the Present Disclosure]

The processing sequence of the information processing system according to the present disclosure is explained next.

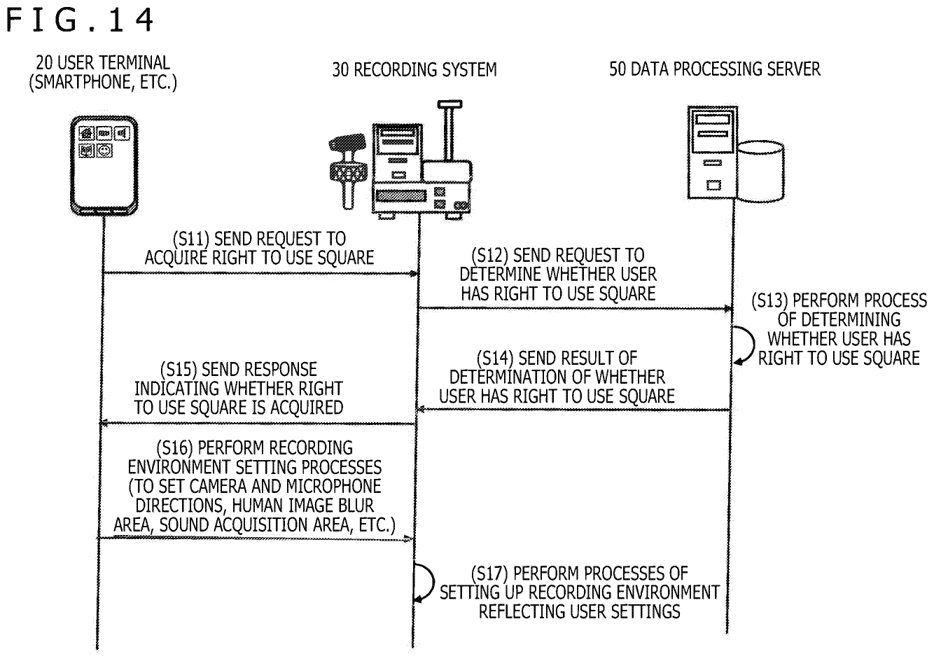

FIGS. 14 through 16 are sequence diagrams explaining the processing sequence of the information processing system according to the present disclosure.

Each of the diagrams has the user terminal 20, the recording system 30, and the data processing server 50 indicated from left to right.

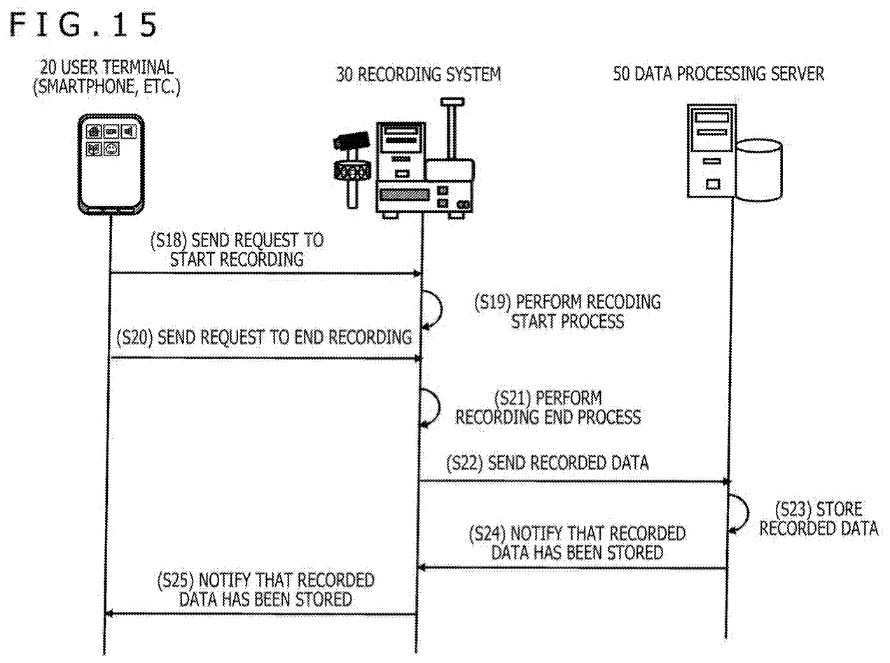

Steps S11 through S25 in FIGS. 14 and 15 represent a series of processes including the process of acquiring the right to use the square, the process of making settings prior to the start of recording, the process of starting the recording, and the process of ending the recording.

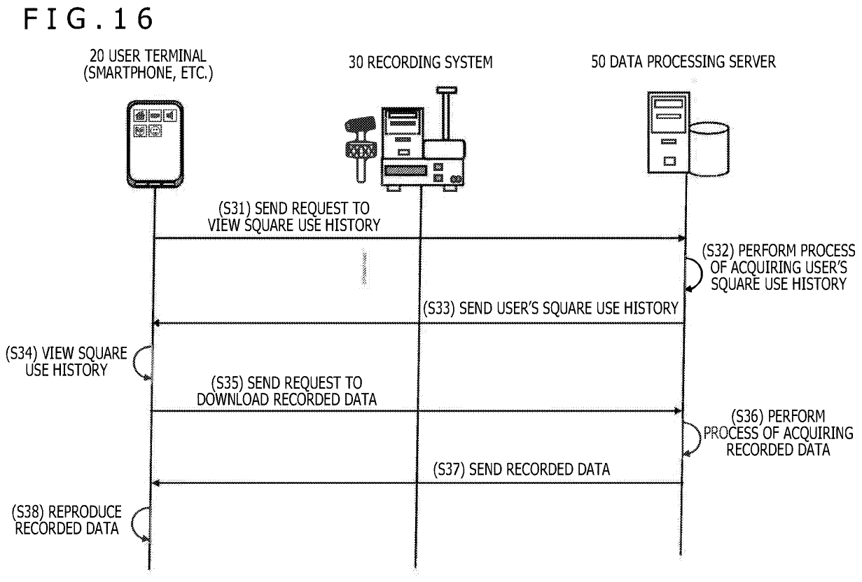

Steps S31 through S38 in FIG. 16 represent a series of processes including those of using the user terminal to view or download the recorded data stored in the data processing server 50 following the recording.

Explained first with reference to the sequence diagrams in FIGS. 14 and 15 are the series of processes including the process of acquiring the right to use the square, the process of making settings prior to the start of recording, the process of starting the recording, and the process of ending the recording.

### (Step S11)

In step S11, the user first sends a request to acquire the right to use the square (recording system use right) to the recording system 30.

This process is carried out by displaying the display screen in FIG. 7(a) described above with reference to FIG. 7, i.e., by displaying “Square Search and Right-of-use Acquisition UI”.

As described above with reference to FIG. 7, (a) Square search and right-of-use acquisition UI is a UI displayed upon access from the user terminal 20 to the square information database in the data processing server 50. The user terminal 20 displays the information registered in the square information database.

For example, displayed are information regarding recording system equipment of each square, information indicative of a distance from the current location, an icon (button) for requesting display of a sketch, the “Gain Access and Acquire Right of Use” operation icon, and the like.

In order to use the square, the user touches the “Gain Access and Acquire Right of Use” operation icon in the UI depicted in FIG. 7.

This process corresponds to sending the request to acquire the right to use the square to the recording system 30 in step S11.

When the user touches the “Gain Access and Acquire Right of Use” operation icon, the user terminal 20 starts short-range communication with the recording system 30 of the public square.

However, as explained above with reference to FIG. 2, the range in which short-range communication is enabled between the user terminal 20 and the recording system 30 is limited. In a case where the user terminal 20 is not within the communication enabled range, the communication is not available, and the right to use the square cannot be acquired.

Once the short-range communication with the user terminal 20 is successfully established, the recording system 30 receives, from the user terminal 20, the request to acquire the right to use the square (recording system use right).

In this process, the data of the request to acquire the right to use the square transmitted from the user terminal 20 includes a user ID recorded in the storage section of the user terminal 20 and a password registered beforehand in the data processing server 50.

This process of data acquisition and transmission is carried out in accordance with a program included in the application (recording system use application) being executed on the user terminal.

(Step S12)

Upon receipt of the request to acquire the right to use the square from the user terminal 20 in step S11, the recording system 30, in step S12, transmits, to the data processing server 50, a request to determine whether or not the user has the right to use the square (recording system use right).

As described above, in a case of using the recording system 30, the user 10 needs to make user registration with the data processing server 50 beforehand.

It is noted that, in step S12, the data to be transmitted from the recording system 30 to the data processing server 50 includes the user ID and password received from the user terminal 20.

### (Step S13)

Upon receipt of the request to determine whether or not the user has the right to use the square (recording system use right) from the recording system 30 in step S12, the data processing server 30, in step S13, performs the process of determining whether or not the user has the right to use the square.

This process involves executing two processes a process of determining whether or not the user ID and the password received from the user terminal 20 by way of the recording system 30 coincide with the data registered in the user information database, and a process of verifying whether or not the right to use the square has already been granted to another user.

Only in the case where the received user ID and password coincide with the data registered in the user information database and where the right to use the square has yet to be granted to another user, the right to use the square (recording system use right) is granted to the user.

In a case where the received user ID and password fail to coincide with the data registered in the user information database or where the right to use the square has already been granted to another user, the right to use the square (recording system use right) is not granted to the user.

### (Step S14)

In step S14, the data processing server 50 notifies the recording system 30 of the result of the process of determining whether or not the user has the right to use the square (recording system use right) in step S13.

### (Step S15)

Next, the recording system 30 notifies the user terminal 20 of the result of the process of determining whether or not the user has the right to use the square (recording system use right) following receipt of the result from the data processing server 50.

In a case where the user is determined not to have the right to use the square (recording system use right), the processing is terminated.

The user then searches for another square and, when an alternative square is found, repeats step S11 and subsequent steps regarding the newly found square so as to make the request to acquire the right of use.

It is assumed here that the user is determined to have the right to use the square (recording system use right). The steps to be carried out on this assumption are explained below.

### (Step S16)

In a case where the user is determined to have the right to use the square (recording system use right), the user causes recording environment setting processes to be carried out using the user terminal 20.

The user terminal 20 executes the recording environment setting processes by conducting short-range communication with the recording system 30.

These processes correspond to the processes described above with reference to FIGS. 9 through 12.

First, the user performs the process of adjusting the camera by making use of the screen depicted in FIG. 9.

In a case where the recording system 30 has a plurality of cameras, the images captured by each of the cameras are displayed.

The user can adjust the camera directions, the zoom settings, and the like by viewing the images captured by each of the cameras.

Next, the user sets the blur filter applied area where the process of blurring with filters is to be performed and the blur filter non-applied area where the blurring process is not to be carried out as explained above with reference to FIGS. 10 and 11.

It is noted that the blurring process is basically performed only on the human-occupied areas inside the blur filter applied area.

Further, the user sets the sound acquisition area explained above with reference to FIG. 12.

These items of setting information are transmitted to the recording system 30 through short-range communication.

### (Step S17)

Next, in step S17, the recording system 30 performs processes of setting up the recording environment in accordance with the user settings by referencing the recording environment setting information received in step S16.

As described above with reference to FIGS. 10 and 11, with respect to each image captured by each camera, the control section (data processing section) 33 of the recording system 30 detects human images from the image of the blur filter applied area and performs the process of applying blur filters to the detected human images to such an extent that the imaged people cannot be identified in preparation for performing the recording process.

Furthermore, the microphones are adjusted to acquire only the sound from the sound acquisition area set by the user through beam forming processing, etc.

As described above, the target of the blurring process is not limited to the human-occupied areas but the blurring process may alternatively be targeted for the entire blur filter applied area. As another alternative, predetermined specific object areas such as the human-occupied areas and character areas may be set as the blur filter applied area.

As a further alternative, the blurring process may be replaced with image processing that changes real objects into unidentifiable forms upon display through filling with color, superposition of pattern images, etc.

### (Step S18)

The recording environment setting processes in steps S16 and S17 are completed before proceeding to step S18.

In step S18, the user terminal 20 transmits a recording start request to the recording system 30.

The recording is started by operating (touching) the recording start designation icon (REC button) on the screen described above with reference to FIG. 9.

When the user operates (touches) the recording start designation icon (REC button) displayed on the user terminal 20, the operation-related information is transmitted to the recording system 30 through short-range communication.

### (Step S19)

Upon receipt of the information related to the operation (touch) of the recording start designation icon (REC button), the recording system 30, in step S19, starts the recording process and stores the recorded data into the storage section 35.

### (Step S20)

Later in step S20, the user terminal 20 transmits a recording end request to the recording system 30.

This process is executed by the user operating (touching) the recording end designation icon displayed on the user terminal 20, the icon having been explained above with reference to FIG. 9.

When the user operates (touches) the recording end designation icon displayed on the user terminal 20, the operation-related information is transmitted to the recording system 30 through short-range communication.

### (Step S21)

Upon receipt of the information related to the operation (touch) of the recording end designation icon, the recording system 30 terminates the recording process in step S21.

### (Step S22)

When the recording process is terminated in step S21, the recording system 30, in step S22, then transmits (uploads), to the data processing server 50, the recorded data stored in the storage section 35.

The images in the recorded data transmitted (uploaded) to the data processing server 50 are those that have undergone the application of blur filters to the human images in the blur filter applied area. That is, all human images in the blur filter applied area are blurred to such an extent that all people are unidentifiable.

Further, the sound in the recorded data transmitted (uploaded) to the data processing server 50 constitutes sound data including little sound from outside of the sound acquisition area.

After transmitting (uploading) all recorded data in the storage section 35 to the data processing server 50, the recording system 30 deletes the recorded data from the storage section 35.

### (Step S23)

When the recording system 30 has transmitted (uploaded) the recorded data to the data processing server 50 in step S22, the data processing server 50, in step S23, stores the recorded data into the storage section 53 therein.

Further, the data processing server 50 adds, to the recorded information database which has been explained above with reference to FIG. 6, entries corresponding to the recorded data that has been recorded anew therein. Using the added entries, the data processing server 50 registers attribute information related to the recorded data such as the recording date and recording location.

### (Step S24)

Upon completing the processes of storing the recorded data and registering the information to the recorded information database, the data processing server 50, in step S24, transmits, to the recording system 30, a notification that the process of storing the recorded data is completed.

### (Step S25)

In step S24, upon receiving, from the data processing server 50, the notification that the process of storing the recorded data is completed, the recording system 30 in step S25 notifies the user terminal 20 of the completion of the process of storing the recorded data to the data processing server 50.

Following the above series of processing, the recorded data stored in the data processing server 50 is processed to such an extent that the images and sounds other than those of the performer are made unidentifiable. If, by any chance, the recorded data is leaked and spread, the problems of infringement of portrait rights or privacy of people, etc. will not occur.

Upon completion of the recording by the user, with the recorded data transmitted (uploaded) from the recording system 30 to the data processing server 50, the data processing server 50 stores the recorded data into the storage section 53 therein and further registers the recorded data to the recorded information database explained above with reference to FIG. 6.

Thereafter, the user 10 can use the user terminal 20 to access the recorded information database in the data processing server 50 to view or download the recorded data.

The sequence of the process of viewing and downloading the recorded data is explained below with reference to the sequence diagram in FIG. 16.

### (Step S31)

First in step S31, the user terminal 20 transmits, to the data processing server 50, a request to view a square use history.

This request includes the user ID.

### (Step S32)

Upon receipt of the request to view the square use history from the user terminal 20, the data processing server 50, in step S32, searches the recorded information database, using, as the search key, the user ID included in the user's request, for entries that coincide with the user ID thereby, acquiring information regarding the user's square use history.

### (Step S33)

Next in step S33, the data processing server 50 transmits, to the user terminal, the information regarding the user's square use history acquired from the recorded information database in step S32.

### (Step S34)

Then, in step S34, the user terminal 20 displays the information regarding the user's square use history received from the data processing server 50.

The display data corresponds to the display data explained above with reference to FIG. 13, for example.

As depicted in FIG. 13, the display section of the user terminal 20 is configured to display a thumbnail representing the camera-captured image in accordance with the recording date and recording location serving as information regarding the recorded data. The user terminal 20 is further configured to be able to output a sample of the recorded sound.

In a case where the data of evaluation by onlookers has been acquired during the recording, the evaluation data is also displayed.

Furthermore, the “Download Recorded Data” icon is displayed as well.

### (Step S35)

The user terminal 20 then transmits a request to download the recorded data to the data processing server 50.

This process is executed by operating (touching) the “Download Recorded Data” icon explained above with reference to FIG. 13.

Operating (touching) the “Download Recorded Data” icon transmits the request to download the recorded data to the data processing server 50.

### (Step S36)

Upon receipt of the request to download the recorded data from the user terminal 20 in step S35, the data processing server 50, in step S36, acquires the recorded data designated by the user from the storage section.

### (Step S37)

After acquiring the user-designated recorded data from the storage section in step S36, the data processing server 50 transmits the recorded data thus acquired to the user terminal 20 in step S37.

### (Step S38)

Finally, upon receipt of the recorded data from the data processing server 50, the user terminal 20 performs processes of reproducing the recorded data thereon or storing the recorded data into the storage section therein in step S38.

### [5. Hardware Configuration Example of the Apparatuses]

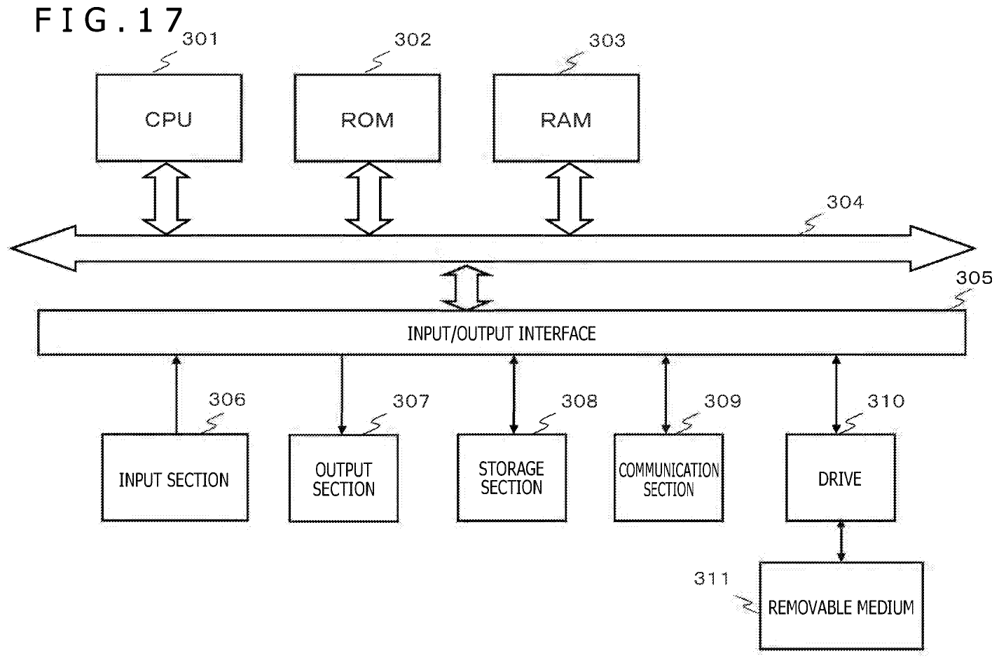

Described next with reference to FIG. 17 is a hardware configuration example of the constituent elements constituting the information processing system that executes processes according to the above embodiment, i.e. the information processing apparatuses constituting each of the recording system 30, the user terminal 20, and the data processing server 50.

The hardware depicted in FIG. 17 is a hardware configuration example of the information processing apparatuses constituting each of the recording system 30, the user terminal 20, and the data processing server 50.

The hardware configuration depicted in FIG. 17 will be described.

A CPU (Central Processing Unit) 301 functions as a data processing section that performs various processes in accordance with programs stored in a ROM (Read Only Memory) 302 or in a storage section 308. For example, the CPU 301 carries out the processes according to the sequence explained in conjunction with the above-described embodiment. A RAM (Random Access Memory) 303 stores programs, data, and the like to be executed by the CPU 301. The CPU 301, the ROM 302, and the RAM 303 are interconnected via a bus 304.

The CPU 301 is connected with an input/output interface 305 via the bus 304. The input/output interface 305 is connected with an input section 306 and an output section 307, the input section 306 being constituted by various sensors, cameras, switches, a keyboard, a mouse, microphones, and the like, the output section 307 being constituted by a display, speakers, and the like.

The storage section 308 connected to the input/output interface 305 includes a hard disk, etc., for example, storing the programs and diverse data to be executed by the CPU 301. The communication section 309 functions as a transmission/reception part performing data communication over networks such as the Internet and local area networks, the communication section 309 thereby communicating with external apparatuses.

A drive 310 connected to the input/output interface 305 drives a removable medium 311 such as a magnetic disk, an optical disk, or a magneto-optical disk, or a semiconductor memory such as a memory card, the drive 310 thereby writing or reading data to or from the removable medium 311.

### [6. Summary of the Configuration According to the Present Disclosure]

The present disclosure has been explained in detail with reference to a specific embodiment. The embodiment, however, may obviously be modified diversely or replaced with another appropriate embodiment by those skilled in the art without departing from the spirit and scope of this disclosure. That is, this invention is disclosed using examples and should not be interpreted restrictively in accordance therewith. The scope of the disclosure should be determined by the appended claims and their legal equivalents, rather than by the examples given.

The technology disclosed in the present description can be implemented preferably in the following configurations.

(1) An information processing apparatus including:

a data processing section configured to receive input of a captured image for image processing,

in which the data processing section performs the image processing of changing a predetermined partial area within the captured image into an unidentifiable image.

(2) The information processing apparatus as stated in (1), in which the data processing section performs the image processing of changing a human image area included in the partial area into an image denying personal identification.

(3) The information processing apparatus as stated in (1) or (2), in which the data processing section performs a blurring process on a human image area included in the partial area.

(4) The information processing apparatus as stated in any one of (1) through (3), in which the data processing section performs a process of detecting a human image from the partial area, and performs the image processing of changing the detected human image area into an image denying personal identification.

(5) The information processing apparatus as stated in any one of (1) through (4), further including:

a short-range communication section configured to have a limited communicable area,

in which the partial area targeted for the image processing is determined on the basis of information input from an external terminal via the short-range communication section.

(6) The information processing apparatus as stated in (5) in which, after determining the partial area targeted for the image processing on the basis of the information input from the external terminal via the short-range communication section, the data processing section starts a recording process in response to a recording start request input from the external terminal via the short-range communication section.

(7) The information processing apparatus as stated in (5) or (6) in which, before completion of the process of determining the partial area targeted for the image processing on the basis of the information input from the external terminal via the short-range communication section, the data processing section does not perform a recording process in response to a recording start request input from the external terminal via the short-range communication section.

(8) The information processing apparatus as stated in any one of (1) through (7), in which the data processing section stores the image having undergone the image processing into a storage section.

(9) The information processing apparatus as stated in (8), in which the data processing section transmits the image stored in the storage section to an external apparatus, the data processing section further performing a process of deleting the stored data from the storage section after the transmission.

(10) The information processing apparatus as stated in any one of (1) through (9), in which the information processing apparatus stores a sound acquired by a microphone from a specific direction into a storage section.

(11) The information processing apparatus as stated in (10), further including:

a short-range communication section configured to have a limited communicable area,

in which a sound acquisition target area is determined on the basis of information input from an external terminal via the short-range communication section.

(12) The information processing apparatus as stated in (11)

in which, after determining the sound acquisition target area on the basis of the information input from the external terminal via the short-range communication section, the data processing section starts a recording process in response to a recording start request input from the external terminal via the short-range communication section, and

before completion of the process of determining the partial area, the data processing section does not perform the recording process in response to the recording start request input from the external terminal.

(13) The information processing apparatus as stated in any one of (1) through (12), in which the data processing section generates a UI (user interface) for outputting to a display section, the UI allowing a user to perform a process of searching for a square where a camera for capturing the image is set up and a process of acquiring a right to use the square.

(14) The information processing apparatus as stated in (13), in which the data processing section generates the UI including information for access to a sketch including information regarding the camera set up in the square.

(15) The information processing apparatus as stated in (13) or (14)

in which, in response to input to the UI by the user desirous of acquiring the right to use the square, the data processing section performs a process of determining whether or not the right to use the square can be granted to the user, and

in a case where any other user has yet to acquire the right to use the square, the data processing section grants the right to use the square to the user desirous of acquiring the right to use the square.

(16) The information processing apparatus as stated in any one of (1) through (15), in which the data processing section generates a UI for display on a display section, the UI allowing a user to set an image area where the image processing of changing into an unidentifiable image is not to be carried out.

(17) An information processing system including:

a user terminal; and

a recording system,

in which the recording system includes
a data processing section configured to receive input of a captured image for image processing, and
a short-range communication section configured to have a limited communicable area, and

the data processing section
receives input of image processing area designation information from the user terminal via the short-range communication section, and
on the basis of the input information, performs the image processing of changing, into an unidentifiable image, a partial area selected from the captured image in accordance with the image processing area designation information.

(18) The information processing system as stated in (17),

in which the data processing section
receives input of sound acquisition target area information from the user terminal via the short-range communication section, and
on the basis of the input information, stores a sound acquired by a microphone from a specific direction into a storage section.

(19) The information processing system as stated in (18),

in which, on condition that the image processing area designation information and the sound acquisition target area are input from the user terminal via the short-range communication section, the data processing section starts a recording process in response to a recording start request input from the user terminal.

(20) An information processing method to be executed by an information processing apparatus,

in which the information processing apparatus includes a data processing section configured to receive input of a captured image for image processing, and

the data processing section performs the image processing of changing a predetermined partial area within the captured image into an unidentifiable image.

(21) An information processing method to be executed by an information processing system having a user terminal and a recording system,

in which the recording system includes
a data processing section configured to receive input of a captured image for image processing, and
a short-range communication section configured to have a limited communicable area, and

the data processing section
receives input of image processing area designation information from the user terminal via the short-range communication section, and
on the basis of the input information, performs the image processing of changing, into an unidentifiable image, a partial area selected from the captured image in accordance with the image processing area designation information.

(22) A program for causing an information processing apparatus to perform information processing,

in which the information processing apparatus includes a data processing section configured to receive input of a captured image for image processing, and

the program causes the data processing section to perform the image processing of changing a predetermined partial area within the captured image into an unidentifiable image.

The series of the processes explained in this description can be executed either by hardware, by software, or by a combination of both. In a case where these processes are to be carried out by software, a program with processing sequences recorded therein is installed to a memory of a computer built with dedicated hardware and is executed by the computer. Alternatively, the program can be installed to and executed by a general-purpose computer capable of performing diverse processes. For example, the program can be recorded beforehand on a recording medium. In addition to being installed to the computer from the recording medium, the program can also be received over networks such as a LAN (Local Area Network) or the Internet and installed on the recording medium such as an internal hard disk.

The processes described above may be executed not only chronologically in the depicted sequence but also parallelly or individually as needed or in keeping with the performance of the apparatus executing the processes. In this description, the term “system” refers to a logical aggregate configuration of a plurality of apparatuses. The apparatuses in such a configuration may or may not be housed in a single enclosure.

### INDUSTRIAL APPLICABILITY

According to the configuration of one embodiment of the present disclosure, as described above, an apparatus and a method are realized to enable performance recording without incurring problems of infringement of portrait rights or privacy.

Specifically, for example, the apparatus includes a data processing section that receives input of a captured image for image processing. The data processing section changes a human image area included in a predetermined partial area within the captured image into an image denying personal identification. For example, a blurring process is carried out. A blurring process target area is determined on the basis of information input from a user terminal via a short-range communication section. After completion of the process of determining the area, a recording process is started in response to a recording start request input from the user terminal via the short-range communication section. Before completion of the area determination process, the recording process is not executed even when the recording start request is input.

This configuration thus realizes an apparatus and a method to enable performance recording without incurring problems of infringement of portrait rights or privacy.

### REFERENCE SIGNS LIST

10: User

20: User terminal

21: Control section (data processing section)

22: Communication section

23: Short-range communication section

24: Storage section

25: Input/output section

30: Recording system

31: Sensors

32: Short-range communication section

33: Control section (data processing section)

34: Communication section

35: Storage section

50: Data processing server

51: Control section (data processing section)

52: Communication section

53: Storage section

101: User information database

102: Square information database

103: Recorded information database

301: CPU

302: ROM

303: RAM

304: Bus

305: Input/output interface

306: Input section

307: Output section

308: Storage section

309: Communication section

310: Drive

311: Removable medium

1. An information processing apparatus comprising:
a data processing section configured to receive input of a captured image for image processing,
wherein the data processing section performs the image processing of changing a predetermined partial area within the captured image into an unidentifiable image.

2. The information processing apparatus according to claim 1, wherein the data processing section performs the image processing of changing a human image area included in the partial area into an image denying personal identification.

3. The information processing apparatus according to claim 2, wherein the data processing section performs a blurring process on a human image area included in the partial area.

4. The information processing apparatus according to claim 2, wherein the data processing section performs a process of detecting a human image from the partial area, and performs the image processing of changing the detected human image area into an image denying personal identification.

5. The information processing apparatus according to claim 1, further comprising:
a short-range communication section configured to have a limited communicable area,
wherein the partial area targeted for the image processing is determined on a basis of information input from an external terminal via the short-range communication section.

6. The information processing apparatus according to claim 5, wherein, after determining the partial area targeted for the image processing on the basis of the information input from the external terminal via the short-range communication section, the data processing section starts a recording process in response to a recording start request input from the external terminal via the short-range communication section.

7. The information processing apparatus according to claim 5, wherein, before completion of the process of determining the partial area targeted for the image processing on the basis of the information input from the external terminal via the short-range communication section, the data processing section does not perform a recording process in response to a recording start request input from the external terminal via the short-range communication section.

8. The information processing apparatus according to claim 1, wherein the data processing section stores the image having undergone the image processing into a storage section.

9. The information processing apparatus according to claim 8, wherein the data processing section transmits the image stored in the storage section to an external apparatus, the data processing section further performing a process of deleting the stored data from the storage section after the transmission.

10. The information processing apparatus according to claim 1, wherein the data processing section stores a sound acquired by a microphone from a specific direction into a storage section.

11. The information processing apparatus according to claim 10, further comprising:
a short-range communication section configured to have a limited communicable area,
wherein a sound acquisition target area is determined on a basis of information input from an external terminal via the short-range communication section.

12. The information processing apparatus according to claim 11,
wherein, after determining the sound acquisition target area on the basis of the information input from the external terminal via the short-range communication section, the data processing section starts a recording process in response to a recording start request input from the external terminal via the short-range communication section, and
before completion of the process of determining the partial area, the data processing section does not perform the recording process in response to the recording start request input from the external terminal.

13. The information processing apparatus according to claim 1, wherein the data processing section generates a UI (user interface) for outputting to a display section, the UI allowing a user to perform a process of searching for a square where a camera for capturing the image is set up and a process of acquiring a right to use the square.

14. The information processing apparatus according to claim 13, wherein the data processing section generates the UI including information for access to a sketch including information regarding the camera set up in the square.

15. The information processing apparatus according to claim 13,
wherein, in response to input to the UI by the user desirous of acquiring the right to use the square, the data processing section performs a process of determining whether or not the right to use the square is able to be granted to the user, and
in a case where any other user has yet to acquire the right to use the square, the data processing section grants the right to use the square to the user desirous of acquiring the right to use the square.

16. The information processing apparatus according to claim 1, wherein the data processing section generates a UI for display on a display section, the UI allowing a user to set an image area where the image processing of changing into an unidentifiable image is not to be carried out.

17. An information processing method to be executed by an information processing apparatus,
wherein the information processing apparatus includes a data processing section configured to receive input of a captured image for image processing, and
the data processing section performs the image processing of changing a predetermined partial area within the captured image into an unidentifiable image.

18. A program for causing an information processing apparatus to perform information processing,
wherein the information processing apparatus includes a data processing section configured to receive input of a captured image for image processing, and
the program causes the data processing section to perform the image processing of changing a predetermined partial area within the captured image into an unidentifiable image.
